(19) United States
(12) Patent Application Publication
(10) Pub. No.: US 2004/0222325 A1
(43) Pub. Date: Nov. 11, 2004

(54) Field programmable drip irrigation system

(76) Inventor: Zvi Regev, West Hills, CA (US)

Correspondence Address: ZVI REGEV, 24217 Highlander Rd., West Hills, CA, 91307, US

(21) Appl. No.: 10/838,580

(22) Filed: May 4, 2004

Related U.S. Application Data
(60) Provisional application No. 60/468,151, filed on May 6, 2003.

(51) Int. Cl. B05B 15/00

(52) U.S. Cl. 239/569

(57) ABSTRACT

This invention describes a drip irrigation system wherein drippers are provided with valves, and wherein these valves are independently and remotely controlled. This invention also describes a drip irrigation system wherein drippers are controlled via a communication network, to turn individual drippers ON or OFF as required.

### FIELD OF THE INVENTION

This invention relates to the field of drip irrigation, and more specifically it addresses the possibility of controlling of individual elements of the irrigation system via a data communication network.

### BACKGROUND OF THE INVENTION

Irrigation systems have been used for generations as the means to allow agricultural utilization of land where natural precipitation is not sufficient. The most ancient method known, employed the flooding of fields. To allow better control and more efficient use of irrigation water, irrigation using canals and trenches replaced field flooding. To allow even better control and water usage efficiency, pipes and sprinklers are used to deliver irrigation water just to the places where irrigation is required. Yet even with sprinklers, unnecessary waste of water can not be avoided. Sprinklers irrigate an area, not just the plants that need to be irrigated. With sprinkler irrigation systems, a large amount of water is still lost due to evaporation, runoff, and the scattering of water droplets by wind.

Drip irrigation systems seem to provide the ultimate method of water conservation. In drip irrigation systems, as in sprinkler systems, pipes are used to deliver the water, but in a drip irrigation system, small emitters also known as drippers are used instead of sprinklers. In a sprinkler based irrigation system, sprinklers are placed in locations that will allow an even distribution of irrigation water over an area. Sprinklers are designed such that water squirted out of the sprinklers will ultimately fall evenly on a large area of coverage assigned to the sprinkler. In contrast in drip irrigation systems only a very small area around a dripper is irrigated. Drippers are placed immediately next to plants, which they irrigate, and thus ultimately irrigate only the roots of the plants to which they are assigned. To place the emitter at the desired locations drip irrigation pipes are made of flexible plastic material, and are not laid in the field in straight lines, as it is customary with sprinkler pipeline irrigation systems. Instead drip irrigation pipeline are meandered between the plants, such that the drippers are located in close proximity to the plants to be irrigated. In low-grade drip irrigation systems, drippers are installed on the outside of the pipeline, next to every plant, or wherever else it is desirable. In professional drip irrigation systems, a dripper is a sophisticated flow control structure placed inside the irrigation pipes with only tiny orifices in the skin of the pipe through which water is squirted out of the pipe. The flow control mechanism typically includes a special narrow and long labyrinth through which water must pass to get to the orifice. As the water passes through the labyrinth, friction with the labyrinth walls causes the water pressure to drop, and as a result water arriving at the orifice are at a low and constant pressure, resulting in an even and measured emission of water from the orifice. During the manufacturing (by extrusion) of the high-grade drip irrigation pipe, the elaborate flow control mechanisms are inserted inside the water delivery pipe, at fixed intervals, and orifices are drilled in the skin of the water-delivering pipe in locations where control mechanisms are placed inside the pipe. In drip irrigation pipelines water is emitted out of the orifices in a slow but constant rate of flow, and is absorbed in the soil in the immediate proximity of the drippers. Thus, water is only delivered where it is necessary, without runoffs, evaporation, and scattering.

Despite all their benefits, drip irrigation systems still suffer from several undesirable problems. In the present drip irrigation systems, all the drippers along the pipe receive water simultaneously, and are expected to deliver the same amount of water everywhere along the pipe, regardless to variations of the specific need at any point along the pipe. The “one flow rate everywhere method”, requires that all the plants along the irrigation system pipe, be homogeneous in type, specie, and size, without room for diversity. Also as the water delivering pipes become long, and with many drippers along the line, a pressure gradient develops along the pipe with a significant pressure difference between the near and far ends of the pipe. As a result, the amount of water delivered by the drippers, drops with the drop in water pressure in the pipe, and water delivery rate becomes uneven. Many improvements in existing drip irrigation emitters are aimed at dealing with equalizing the water delivery rate in long pipelines despite the water pressure drop along the line.

### DESCRIPTION OF THE PRIOR ART

Typical prior art drippers follow the basic diagram shown in FIG. 1. The differences between various dripper designs are typically limited to methods of reducing the water pressure between the water delivery pipe, and the orifice, methods of controlling the flow rates, and methods for avoiding clogging of the water passages and the orifices. A prior art drip irrigation system is shown in FIG. 2, wherein a plurality of drippers are installed along pipelines, and wherein a plurality of dripping pipelines are combined to form the irrigation system, and further wherein the flow of water in each dripping pipeline is controlled by a shutoff valve.

Technologies such as Micro-machined Electro Mechanical Systems (MEMS), and magnetic latches, used in embodiments of electronically controlled valves described in this invention, have been demonstrated in prior art.

### SUMMARY OF THE INVENTION

This invention describes a solution for problems associated with drip irrigation systems, in a way that allows precise control over the delivery of water at any individual water delivery point in the entire system. The primary and foremost reason for the deployment of drip irrigation system is to deliver irrigation water in the most efficient and conservative way. For this purpose it is desirable to be able to control the amount of water delivered at any distinct point in the area covered by the irrigation system.

According to this invention, each dripper is fitted with an electrically controlled water valve that can enable or stop the flow of water out of the said dripper. Also according to this invention, the valve of each and every dripper can be individually controlled, remotely, via an electronic communication network.

An electronic valve to control the water flow in an individual dripper must comply with certain requirements. It must be small in size, such as to fit inside emitter flow control mechanisms, which in turn are installed inside the water delivery pipe, without obstructing the flow of water in the pipe. It must be very reliable to guarantee millions of ON/OFF operations without failure. It must be maintenance free. It must operate with, and consume very little power. It must not be clogged by water regularly used in agriculture, and it must be controlled via a communication network.

The electronic valve to be used in an electronically controlled dripper, and comply with the requirement set forth above, may be produced using Micro-machined Electro-Mechanical System (MEMS) methods. Micro stepper motors, racks and gears have already been demonstrated, on a single semiconductor chip, using MEMS technology, and a valve based on a sliding bolt, or a flexing level, motivated by a micro stepper motor, a gear and a pinion, Piezo-electric force, are examples of possible embodiments. Alternative embodiments may be based on a sliding bolt activated by an electro-magnetic field, and held in place by a magnetic latch, wherein a short electrical current impulse switches the valve ON or OFF. A hydraulic mechanism controlled by means described above, and assisted by the static pressure of the water in the pipe is also conceivable as device to be used for a controlled valve.

A communication network to control the drip irrigation system must be able to connect to each and every dripper in the system, address each dripper individually, and control its operation. Power must also be delivered to every dripper to operate the emitter valve and an associate controller. In an embodiment described by this invention, a special network can be used both as communication media, and as a power delivery conduit to all the drippers in the system. For system reliability, given the fact that drip irrigation systems are deployed in field where both humans and machines work, the communication and power delivery network may needs to include redundant communication and power delivery paths to allow continuous failure free operation. Ultimately a communication system should have a command and response provision to allow inquiry into the status and condition of a dripper, and even provide information generated by sensors placed outside of the dripper.

In order to facilitate the communication via the communication network, to receive instructions over the network, to interpret such instructions, and to control the operation of the emitter, each dripper is equipped with an associated electronic controller. The said controller may also detect events of malfunction of the dripper or its valve, and report the status of the dripper back to the system's master controller.

Drip irrigation systems are typically deployed such that main feeder lines are connected to the main water source valve, and arms of water delivery pipes fitted with drippers connect as multiple parallel arms to the main feeder lines. To allow for redundancy in both water delivery paths and data communication and power access, the water delivery pipes as well as the communication and power delivery network are each connected to the main feeder lines and to the system controller on both ends of each of the arms. With this redundant connection, a break in the network path in an arm will not prohibit the power delivery to, and the communication with drippers on that arm, as they are still connected through the redundant connection. The communication protocol is designed to allow the redundant connection.

In an alternative embodiment and method of deployment, each dripper is equipped with a small solar cell to power the dripper's valve and controller. Such solar sells are typically seen on pocket calculators and other small appliances, and can provide just enough electrical power to the emitter valve, the controller, and the means for communication with the controller. A two-way radio communication device attached to the dripper's controller allows the establishment of a UHF wireless communication network between the dripper and the system controller. Such a network will enable the system controller to directly control each individual dripper in the drip irrigation system. Other embodiments including the use of optical fibers as means to facilitate power delivery and a communication network are also conceivable. In such cases, the optical fiber provides a conduit to pipe high intensity light to every dripper. In every dripper, a photocell replaces the solar cell described above, as the means to convert light into electrical power.

Ability to control the water flow in each individual dripper, regardless of the operation of other drippers on the line, allows for the outmost utilization of the dripper pipeline, and to avoid needless waste of water. In the system described by this invention, the amount of water delivered by a dripper is controlled by the length of time at which the dripper's valve is turned ON. Each dripper is uniquely identified by an address or code, and may be turned ON for a desired duration. Each dripper may be individually turned ON and OFF using the direct control of communication system, or as an additional option, each dripper may be programmed, in the field, to turn ON at specified times for a certain lengths of time. Broadcast type commands may simultaneously address all, or any group of drippers, set to be controlled consequently. Sensors attached to the communication system and installed in the field can provide information on soil humidity at different locations and different depths, and thus further modify the dripper's control programs to allow the ultimate efficiency in water usage.

### A BRIEF DESCRIPTION OF THE DRAWINGS

The theory of operation of this invention, its objectives, and advantages, along with its distinction from prior art, will be best understood from the study of the following description taken along with the accompanying drawings in which:

FIG. 1, Shows the construction of prior art drippers.

FIG. 2, Show a typical deployment of a prior art drip irrigation system.

FIG. 3, Shows an embodiment for a valve based on MEMS technology, to be integrated into a programmable dripper.

FIG. 4, Shows an embodiment of an electrically controlled valve based on a magnetic latch.

FIG. 5, Shows a typical deployment of a field programmable drip irrigation system in accordance with this invention,

FIG. 6, Shows an embodiment of a field programmable dripper.

FIG. 7, Shows an embodiment of a drip irrigation system utilizing wireless communication, and solar power.

FIG. 8, Shows an embodiment of a dripper assembly to be used in the wireless drip irrigation system.

FIG. 9, Shows an embodiment of a communication interface for wired drip irrigation systems.

FIG. 10, Shows an embodiment for a communication interface for wireless drip irrigation systems.

FIG. 11, Shows an embodiment of the irrigation system master controller for wired system deployment.

FIG. 12, Shows an embodiment of the irrigation system master controller for wireless system deployment.

FIG. 13, Shows an example of a communication protocol in wired drip irrigation systems.

FIG. 14, Shows an example of a communication protocol in wired drip irrigation systems, where a response is expected.

FIG. 15, Shows an example of a communication protocol in wireless drip irrigation systems.

FIG. 16, Shows an example of a communication protocol in wireless drip irrigation systems, where a response is expected.

### DETAILED DESCRIPTION OF THE INVENTION

In the following detailed description, reference is made to the accompanying drawings, which form a part hereof, and in which are shown by way of illustration of specific embodiments in which the invention may be practiced. These embodiments are described in sufficient detail, to enable those of ordinary skill in the art, to make and use the invention. It is to be understood that structural, logical or procedural changes may be made to the specific embodiments disclosed without departing from the spirit and scope of the present invention.

To allow sufficient water supply to all the drippers on very long dripping lines, either the pipe must be large in diameter, or the pressure in the pipe must be high. Since a large diameter pipe is undesirable, drip irrigation systems are typically based on high water pressure in the dripping pipes. A hole in the skin of a highly pressurized water pipe causes a high-pressure jet of water to be squirted out of the hole. The amount of water coming out of the hole is uncontrolled and depends both on the water pressure inside the pipe, and the diameter of the hole. To eliminate the possibility of such water jets, a controlling device is required between the highly pressurized water in the inner part of the pipe, and the orifice on the skin of the pipe. The pressure reduction is achieved by allowing the water to flow through very long and narrow passages, in which friction slows down the velocity of the water current, and thus reduces the pressure as the water flows through these passages. The design of such pressure reduction devices is prior art, and is not a subject dealt with in this invention.

The pressure controlling mechanisms in prior art are not designed to allow intentional blockage of the water flow to the orifice.

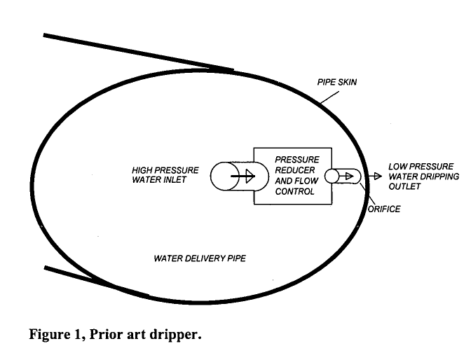

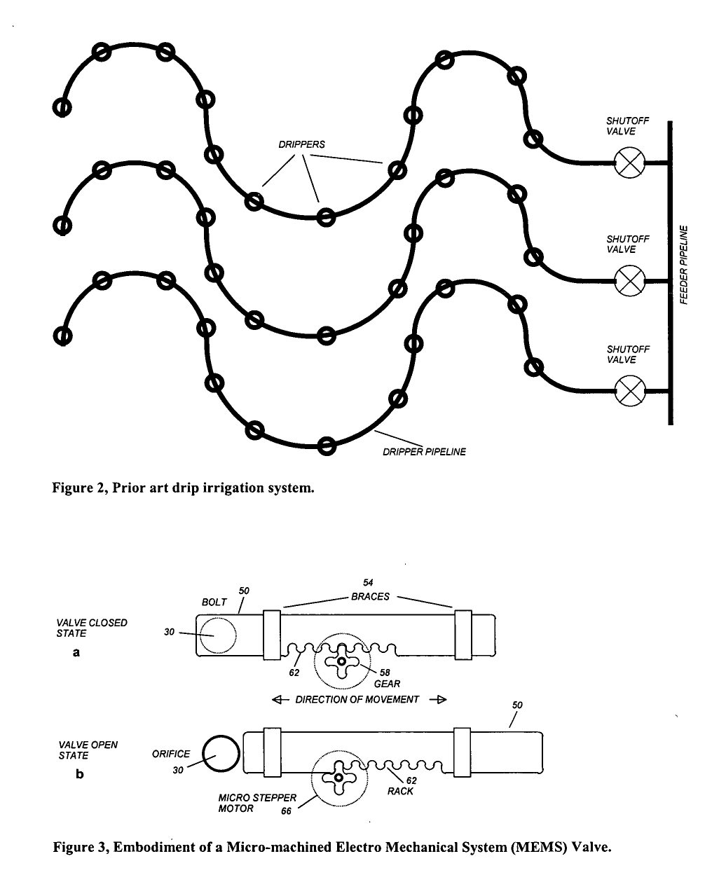

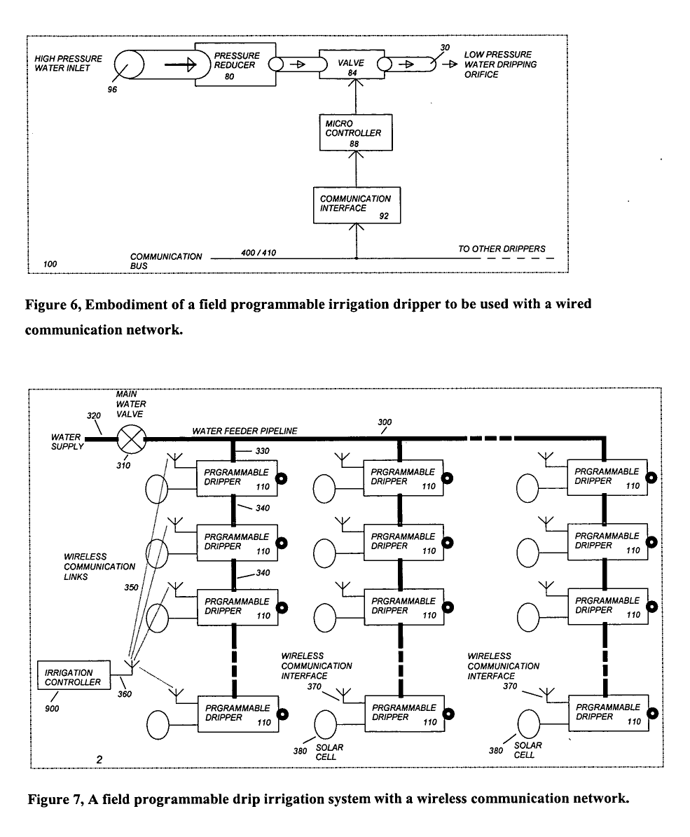

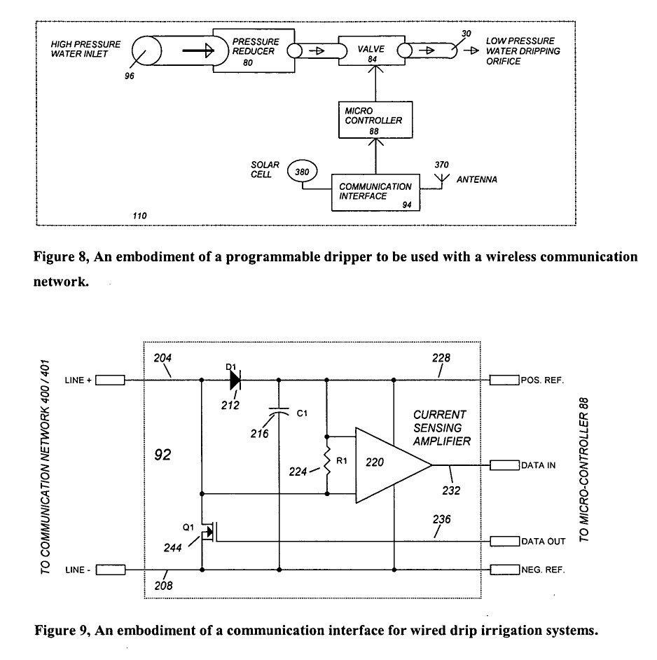

Referring primarily to FIG. 6, which shows the field programmable dripper 100 in accordance with this invention. Unlike prior art drippers shown in FIG. 1, wherein water passes from the inside of the water delivery pipe through the pressure reducing control section to the emitter orifice on the pipe's skin, in the dripper 100 shown in FIG. 6, an electrically controlled valve 84 is added between the pressure reducer 80 and the orifice 30, as show in FIGS. 6, and 8. An electronic controller 88, and a communication network interface 92, and 94, are also added to enable the remote or local control of the valve 84. With the valve 84 and the controller 88, the amount of water emitted through the orifice 30 depend mainly on the length of time the valve 84 is open, and to a much lesser degree to the water pressure at the output of the pressure reducer 80.

This invention goes beyond the addition of the valve in the dripper, and encompasses the entire irrigation system. With the advent of a controlled valve 84 in a dripper, a controller 88, and a communication network 92 in place, a system to control each individual dripper is put in place. Thus, according to this invention, each dripper 100, 110, becomes a smart dripper, comprising control and communication facilities. To utilize the control and communication capabilities of the smart drippers 100, 110, a control and communication network is required. Although there are multiple ways to implement the desired drip irrigation system with its communication and control network, only two embodiments are discussed in this invention, in order to demonstrate how this invention can be reduced to practice. Two possible embodiments of drip irrigation system deployments, utilizing valve-controlled drippers are shown in FIGS. 5, and 7 respectively. The drip irrigation system deployment shown in FIG. 5, depicts an embodiment of a system 1 with a control and communication system as well as operational power applied via electrical conductors.

The embodiment shown in FIG. 7, depicts a similar drip irrigation system 2 wherein a wireless control and communication network is used.

In the deployment shown in FIG. 5, the dripper local electronic controller 88 communicates with the system's master control 200 via the communication network 400, 410. Through the communication network 400,410, the electronic controller 88 receives messages sent by the master controller 200, responds to received commands, activate specific irrigation programs, controls the operation of the valve 84, and reports the status of the dripper 100 back to the master controller 200. Upon receiving a specific control signal, the valve 84 is opened to allow the flow of water to the orifice, and upon a different control signal, the valve 84 closes, and stems the flow of water.

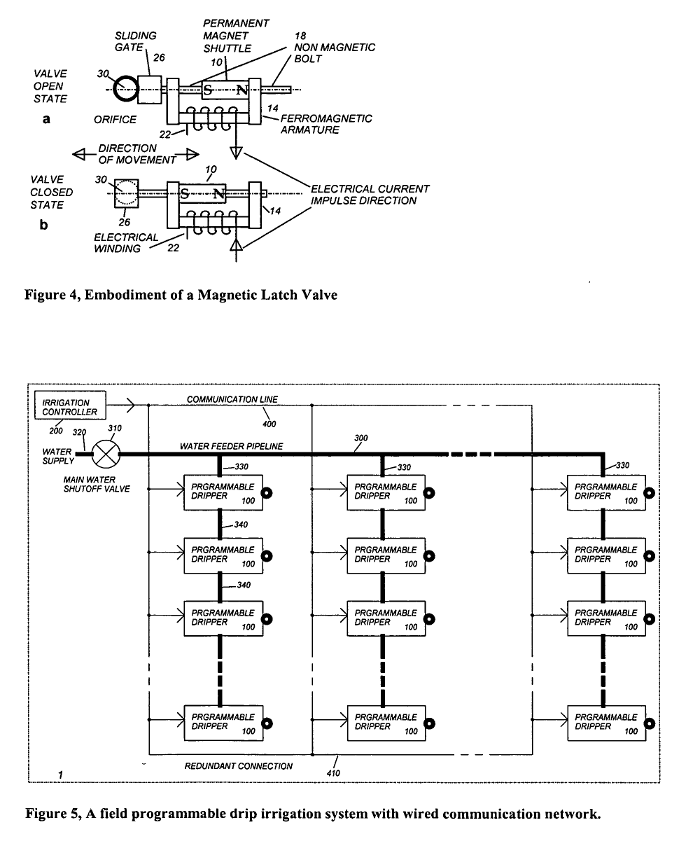

Two embodiments for the valve 84 are shown in FIGS. 3, and 4 respectively. FIG. 3, shows an embodiment of a valve 84 based on the Micro-machined Electro Mechanical System (MEMS) technology. Here the valve 84 is based on a sliding bolt 50. Part of the bolt 50 is machined as a rack 62. The bolt 50 is held in place by the braces 54, which allow the bolt 50 a lateral movement from right to left and from left to right. A micro stepper motor 66 has a gear 58 on its spindle. The gear 66 in turn is engaged with the rack 62. When the motor 66 turn counter clockwise, it causes the bolt 50 to move left, and block the orifice 30. When the motor 66 turn clockwise, the bolt 50 moves to the right unblocking the orifice 30 and allowing the flow of water through the orifice 30.

FIG. 4, shows an alternative embodiment of an electrically controlled valve 84. In this embodiment, a permanent magnet shuttle 10 is mounted on a non-magnetic bolt 18, which can move laterally from right to left and from left to right inside the armature 14, which is made of a ferromagnetic material. An electrical wire 22 is wound on the armature 14. When an electrical current is conducted through the electrical winding 22, it causes the armature 14 to become magnetized, wherein the polarity of the resulting magnetic flux depends on the direction of electrical current flow in the electrical winding 22. Thus an impulse of electrical current through the electrical wire winding 22, in one direction, causes the armature 14 to become temporarily magnetized, causing the permanent magnet shuttle 10 to be expelled from one side of the armature 14, and to be attracted by the opposite side of the armature 14, forcing the shuttle 10 to slide, along with the bolt 18, from one side to the opposite side of the armature 14. When the electrical current impulse has ended, the magnetic flux through the armature 14, caused by the current flow through the windings 22 is terminated. However, the shuttle 10, being a permanent magnet, is still attracted the ferromagnetic armature 14, and thus does not move. An impulse of electrical current, flowing in an opposite direction, causes a magnetic flux in the opposing direction through the armature 14, causing the shuttle 10 to be expelled from the side of the armature 14 where it is in rest, and to be attracted to the opposite side of the armature 14. This causes the shuttle to slide back to its initial position. A sliding gate 26 is attached to one end of the bolt 18. When the shuttle 10 and the bolt 18 move to the left, the gate 26 blocks the flow of water through the orifice 30. When the shuttle 10 and the bolt 18 move to the right, the gate 26 slide to the right as well, unblocking the orifice 30, and allowing the flow of water through the orifice 30.

The electronic controller 88 is a simple low power electronic controller, having the facilities to communicate via the communication network, and to activate the electrically controlled valve 10. In the irrigation system, each dripper 100 is assigned a unique identification address, stored permanently inside the controller 88. The electronic controller uses this address to identify messages and commands sent over the communication network 400, 410 by the system's master controller 200, and only accept those messages for which it is the addressee. The controller 88 interprets commands it receives, and follows in action after the instructions. Upon command it turns the valve 84 ON or OFF. Upon different commands, the controller 88 stores new operational programs received from the master control 200 via the network 400, 410, or it modifies existing ones. The micro-controller 88 can also run programs autonomously, turn the water flow in the dripper ON and OFF automatically, based on a pre-programmed schedule.

The control and communication network can be implemented using electrical wires, as depicted in deployment 1, shown in FIG. 5. In this embodiment, all the drippers 100 are connected through electrical wires into a communication network 400, 410 that doubles also as the source of power to all the drippers 100 in the system. In an alternative type of deployment 2, shown in FIG. 7, the drippers 110 are each completely independent. As the drippers 110 are not connected to electrical wires as means to provide power and a communication conduit, each dripper 110 must generate its own power, and communicate with the system's master controller 200 via electromagnetic waves, such as radio waves. For that reason, each dripper 110 comprises its own solar power source 380, and a radio transceiver 94 and an antenna 370, to communicates with the system's master controller 200 via a wireless communication network, as shown in FIG. 7.

The programmable drippers 110 are similar to the drippers 100, except for their power source and communication interface. The communication interface 92 in the drippers 100 is designed to interface to a communication network via electrical conductors, wherein the communication interface 94 in the drippers 110 is based on a radio transceiver connected to an antenna 370, which enables a wireless communication network interface. An embodiment of the communication interface 92 is shown in FIG. 9. The communication network 400, 410, is comprised of two electrically conducting wires. A potential voltage difference is normally applied between the two conductors, such that the LINE+ 204 is at a potential more positive with respect to the conductor LINE− 208, which is also the negative reference potential for all the electronic circuits in the dripper 100. Under these conditions electrical current can flow through the diode 212, and charge the chargeable battery 216. The negative side of the battery 216 connects to the negative reference 208, and the positive side of the battery 216 connects to the positive reference 228, which becomes the positive supply for all the electronic circuits in the dripper 100. If the potential between the lines LINE+ 204, and LINE_208, becomes smaller than the potential on the battery 216, the diode 212 stops conducting, a condition know to the skilled in the arts of electronic circuits as the condition of “reverse bias”, and thus the battery 216 can not discharge through the diode 212, and the battery 216 remains charged.

The irrigation system master controller 200 in the system deployment 1, shown in FIG. 5, is both the source of power for the entire system, and the controller of the system. An embodiment of the controller 200 is shown in FIG. 11. Since the lines of the communication network may be very long and thin, there may be significant voltage differences between different physical locations on the network. For that reason, the data communication over the network is conducted in the form of electrical current flows, and not voltages, as is typically the case in data communication networks. The convention used in this invention considers the presence of current flow as the logic state of “1”, and the absence of electrical current flow is interpreted as the logic state of “0”.

The master controller 200 comprises of a power supply 466, a master micro-controller 490, a power switch 458, a current sensing amplifier 470, and the transistor 478. Both the supply of power to all the drippers in the system, and data communication are conducted via the communication network 400, 410. All communications are initiated by the system's master control 200. In idle operation, when communication is not conducted, the controller 490 asserts the power switch 458 to the close position, allowing the flow of electrical power to all the drippers 100 in the system 1. To begin a communication session, the master, the controller 490 asserts the power switch 458 to the open position, disconnecting the power supply 466 from the LINE+ 204 in the communication network 400, 410. At this state, the power supply does not force the line 204 to a certain potential with respect to the line 208. This state is sensed by the communication interfaces 92, of all the drippers 100, as the logic state of “0” , or “idle”. At this state no electrical current is flowing through the communication network 400, 410, line, either into or out of any dripper 100 in the system 1. When the controller 490 asserts the transistor 478 to the ON state, the transistor 478 places a “short” between the lines 204, and 208, causing electrical current to flow in every dripper 100, from the rechargeable battery 216, through the resistor 224, into the line 204, the transistor 478, and the line 208. As a result of this flow of electrical current, a voltage is developing across the resistor 224, following Ohm's law V=IR, wherein V is the voltage across the resistor, I is the electrical current, and R is the resistance of the resistor 224. The voltage developing across the resistor 224, is sensed by the amplifier 220, and interpreted as logic condition of “1”. By asserting and de-asserting the transistor 478, the controller 490 causes electrical currents to flow out of the drippers 100, when the transistor 478 is asserted ON, and no current flows when the transistor 478 is asserted OFF, thus generating successions of “1”s and “0”s received in all the drippers 100 in the system 1.

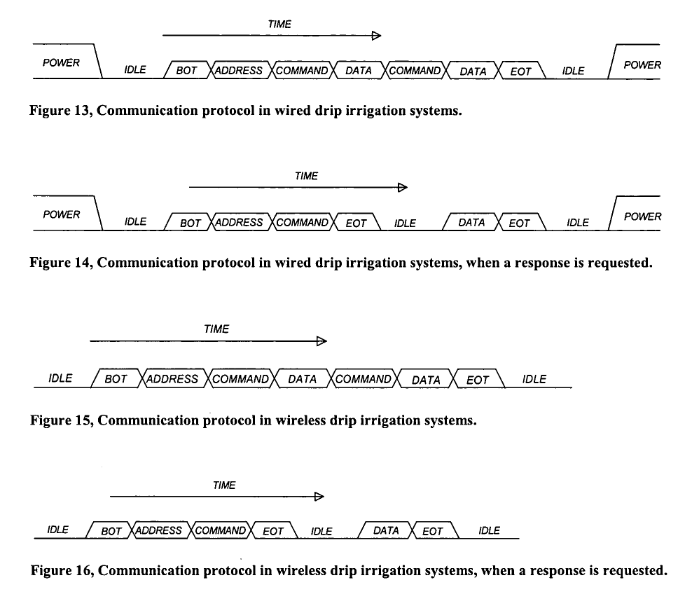

All communication sessions in the system 1 follow a protocol shown in FIGS. 13, and 14. A communication session starts with the disconnection of power, which brings about an idle period. Following the idle the transmission commences with the transmission of a succession of “1”s and “0”s in a special pattern which indicates the Beginning Of the Transmission (BOT). The BOT pattern is followed by an address pattern, indicating to which dripper 100 that particular message is intended. Though all the drippers 100 in the system 1 receive the transmission simultaneously, only the dripper 100 to whom the transmission is addressed responds to the transmission, and acts in accordance with the commands that follow. The address is followed by a command that may be trailed by data associated with the command. A single transmission may contain several commands and data segments. At the end of the transmission an End Of Transmission (EOT), code is inserted, followed by an idle period before the resumption of flow of power to the drippers 100. When a command in the transmission requires a response by the dripper 100 addressed by the command, the communication protocol follows the example in FIG. 14, and allows the designated dripper to respond, at the proper time, by asserting its transistor 244 to the ON or OF states, thus allowing current flows through the resistor 474 in the system's controller 200, which is sensed by the amplifier 470. Data generated by the amplifier 470 is transferred to the micro0controller 490 in the system's controller 200. Since only one dripper is addressed in this mode of operation, only that one dripper is responding, avoiding any data collisions on the communication network.

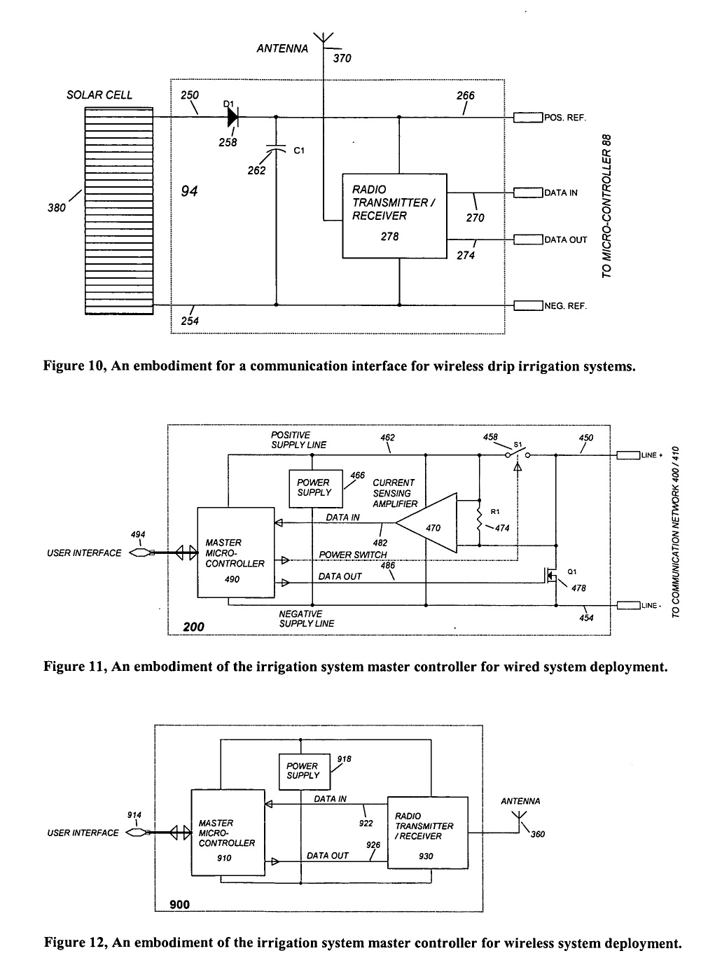

The sources of power, and the means of communication are different in the wireless drip irrigation system deployment 2. In this deployment the drippers 110 are used, where each comprises of the pressure reducer 80, the valve 84, the micro-controller 88, the communication interface 94, the solar cell 380, and the antenna 370, the embodiment of which is presented in FIG. 8. In the drippers 110, the communication interface 94 is used, and its embodiment is shown in FIG. 10. The communication interface 94, uses the solar cells 380 as the power source to charge the batteries 262, through the diode 258. The batteries 262 are required, to guarantee operation at night times. A tiny radio transmitter/receiver (transceiver) 278, and the antenna 370 are used as the means of communication. Since all the communication sessions are initiated by the system's master controller 900, all the drippers 110 have their transceivers 278 in the receive mode, and there are no transmissions. The embodiment of controller 900 for the system 2, is shown in FIG. 12, and it comprises of the master micro-controller 910, the power supply 918, the transmitter 930, and the antenna 360. The controller initiates a communication session by broadcasting a radio message, which is received by the radio receives 278 in all the drippers 110. The message is comprised of data in a format shown in FIG. 15. The message starts with a Start Of Transmission (SOT) code, followed by an address indicating to which dripper 110 the message is intended. There after the message continues with a command, which may be followed by data related to that command. Several commands and data segments may be stringed in a single message. The message ends with an End Of Transmission (EOT) code. If the command transmitted requires a response from the dripper 110 to whom the message was addressed, the controller 900 goes off the air at the end of its message, and waits to receive the response from the dripper 110 as shown in FIG. 16.

While the invention has been described in detail in connection with preferred embodiments known at the time, it should be readily understood that the invention is not limited to the disclosed embodiments. Rather, the invention can be modified to incorporate any number of variations, alterations, substitutions or equivalent arrangements not heretofore described, but which are commensurate with the spirit and scope of the invention.

What is claimed to be a new and original invention, desirous of the protections of a U.S. patent is:

1. A water emitter used in an irrigation system containing at least one controlled valve.

2. A water emitter as in claim 1 wherein a valve is used to control the flow of water through the emitter to an orifice.

3. A water emitter as in claim 1 wherein a valve is independently controlled.

4. A water emitter as in claim 1 wherein a valve is remotely controlled.

5. A water emitter as in claim 1 wherein a valve is activated by means of electrical power.

6. A water emitter as in claim 1 wherein a valve activity is determined by an electronic controlling device.

7. A water emitter as in claim 1 wherein a valve mechanism is based on Micro-machined Electro Mechanic System (MEMS) technology.

8. A water emitter as in claim 1 wherein a valve mechanism is based on an electro-magnetic action.

9. A water emitter as in claim 1 wherein a valve mechanism is assisted by hydraulic power.

10. A water emitter as in claim 1 comprising a plurality of valves wherein any part of the plurality of valves may be activated in order to control the water flow rate out of the orifice.

11. An irrigation system comprised of a plurality of water emitters each including a valve and a means to control said valve.

12. An irrigation system as in claim 11 wherein valves in water emitters are remotely and independently controlled.

13. An irrigation system as in claim 11 wherein valves in emitters are controlled by means of electrical power.

14. An irrigation system as in claim 11 wherein said controlled emitters have unique identification addresses.

15. An irrigation system as in claim 11 wherein individual water emitter valve controllers connect to a communication network.

16. An irrigation system as in claim 11 wherein emitter valve controllers connect to a control and communication network.

17. An irrigation system as in claim 11 wherein water emitters receive operating power via a communication and control network.

18. An irrigation system as in claim 11 wherein valves in water emitters receive operating electrical power from photovoltaic cells.

19. An irrigation system as in claim 11 wherein emitters receive operating power via an optical fiber.

20. An irrigation system as in claim 11 wherein water emitters receive instructions via a communication and control network.

21. An irrigation system as in claim 11 wherein water emitter controllers may be programmed via a communication and control network.

22. An irrigation system as in claim 11 wherein water emitters may be programmed to operate independently in accordance with a preset program.

23. An irrigation system as in claim 11 wherein water emitters may respond to specific instructions delivered via a communication and control network.

24. An irrigation system as in claim 11 wherein water emitters connect to a control and communication network comprised of at least one electrical conductor.

25. An irrigation system as in claim 11 wherein water emitters connect to a wireless control and communication network.

26. An irrigation system as in claim 11 wherein a communication network may be facilitated by the transfer of data or instructions from one emitter controller to another emitter controller in a chain as in a bucket brigade fashion.

27. An irrigation system as in claim 11 wherein both ends of a control and communication network chain are connected to a system controller.

28. An irrigation system as in claim 11 wherein a communication and control network is embedded in the water delivery pipes.

29. An irrigation system as in claim 11 wherein a communication and control network comprises of an optical fiber.

30. An irrigation system as in claim 11 wherein a communication and control network implements wireless communication.

31. An irrigation system as in claim 11 wherein the data communication over the communication and control network is achieved by varying of electrical current.

32. An irrigation system as in claim 11 wherein a system controller governs the operation of the entire or any segment of the irrigation system and instructs the activities of individual emitters.

33. An irrigation system as in claim 11 wherein the water delivery pipes are made of a polymer material.

34. An irrigation system as in claim 11 wherein every valve controller has a unique identification code.

35. An irrigation system as in claim 34 wherein unique identification codes of valve controllers are embedded in the valve controllers.

36. An irrigation system as in claim 34 wherein a codes pertaining to the identification of water emitters is marked on the outside surface of the water-delivery pipes in close proximity to the physical location of the said water emitters.

37. An irrigation system as in claim 11 wherein the logical identification code of emitters is marked on the outside surface of the water delivery pipes as a bar code.

38. An irrigation system as in claim 11 wherein electronic circuits are embedded in the water emitter and used as means to control valves.

39. An irrigation system as in claim 38 wherein the electronic control circuit comprises a digital circuit.

40. An irrigation system as in claim 11 wherein a valve activity is based on preprogrammed operation schedule.

41. An irrigation system as in claim 11 wherein valve activity is modified by acquired external environmental conditions.

42. A water emitter used in an irrigation system containing at least one valve.
